(19) United States
(12) Patent Application Publication
(10) Pub. No.: US 2019/0080630 A1
(43) Pub. Date: Mar. 14, 2019

(54) Medical grade wearable eyeglasses with holographic voice and sign language recognition duo interpreters and response with microphone/speakers using programming software, optional customization via smartphone device or private webpage

(71) Applicant: Alida R. Nattress, Emeryville, CA (US)

(72) Inventor: Alida R. Nattress, Emeryville, CA (US)

(21) Appl. No.: 15/699,328

(22) Filed: Sep. 8, 2017

(51) Int. Cl. G09B 21/00; G10L 21/10; G10L 15/26

(52) U.S. Cl. CPC G09B 21/009; G10L 2021/065; G10L 15/265; G10L 21/10

(57) ABSTRACT

Wearable eyeglass/eyewear programmed to recognize sign language hand gestures that are then interpreted into voice through imbedded microphone and spoken voice to the wearer is received by a sound receptor which then translates that into sign language and displays it holographically onto a lens of the eyeglass for the wearer of device. Device allows such custom features of turning off the voice translator, adjust volume level of voice, working with their mobile devices including Bluetooth capabilities, and activity indicators.

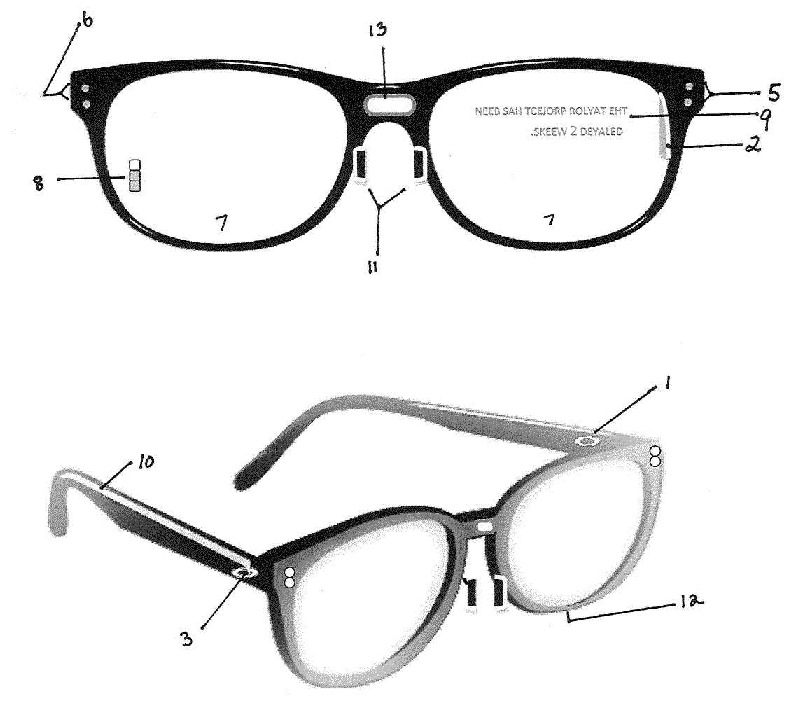

### BACKGROUND OF INVENTION

It is estimated there are 70 million individuals worldwide, nearly 39 million of them in the United States, who are deaf or have severe hearing loss to be considered fully impaired, most using a version of sign language to communicate. With the birth of augmented, neural network, artificial intelligence devices being developed, it is logical to develop a wearable device for a deaf individual to use that would not only see their sign language hand signals and interpret as well as transmit it into a voice for others to understand what they were saying, but it would also “hear” by voice recognition and in turn, interpret the spoken word into a sign language visual on the inside of the left lens of the wearable glasses/headwear, seen only by the wearer, allowing a near seamless communicative interaction with each other.

Around 35% of U.S.A. deaf population are of working age, however, they do not work but rather collect government support funding due to the difficulty in performing at a work place, understanding directions and conversations, or interacting with others, especially those on a phone system. This wearable device (interpretive glass wear) allows the individual to visually see the words being spoken to them, whether the speaker is before them or coming over a speaker phone or computer web service, and they in turn, are now able to respond/interact back.

This device additionally provides some relief to lower- and higher-level education systems from paying for translator services while also making higher-level educational programs a reality for those disabled with being deaf/mute/hearing loss impaired to pursue education like the general population so they may pursue careers that match their talents.

### BRIEF SUMMARY OF INVENTION

A wearable device, which are augmented eyeglasses outfitted with a speaker, speaker receptor, and visual imaging glass (as seen on other wearable devices, i.e., Google glass), for a deaf individual to use that would not only see their sign language hand signals and interpret plus transmit it into a voice for others to understand what they were saying with a customized voice and sound level, but it would also “hear” by voice recognition and in turn, interpret the spoken word into a sign language visual on the inside of the left lens of the wearable glasses/headwear, seen only by the wearer, allowing a near seamless communicative interaction with others.

The wearable device offers the wearer the ability to adjust the volume of the spoken voice via a sliding or tapping switch on the glass earpiece, which is confirmed by a incremental placement level displayed as a colored box on the right lens , turn it on or off with a switch on the opposing earpiece on the glasses, confirmed by a colored line on the left lens as to whether it is actively on.

The device's WiFi capability will allow it to be customized with a Smartphone device, tablet, or through a private webpage on the manufacturer's managing website, with such customizations as selecting the gender and general age for the voice to be transmitted.

The device will be offered initially for American English speaking/interpretation with American Sign Language interpretation, however, future versions will allow the wearer to select from a constant growing offering of other speaking languages and dialects, and sign language interpretations. These features will accommodate the diverse ethnicities unique to each community worldwide.

### DETAILED DESCRIPTION OF THE INVENTION

A wearable device, which are augmented eyeglasses outfitted with a speaker, speaker receptor, and visual imaging glass (as seen on other wearable devices, i.e., Google glass), for a deaf individual to have their sign language hand signals seen by a motion/visual receptor imbedded within the center of the eyeframe that are then interpreted and transmitted out of a speaker for others to understand what they were saying with a customized voice and sound level, and it would also “hear” by voice detection and in turn, interpret the spoken word into a sign language visual on the inside of the left lens of the wearable glasses/headwear, seen only by the wearer, allowing a near seamless communicative interaction with others.

Wearable device will have double light weight lenses on both sides which will serve multiple purposes. Not only will they remain clean between the lenses from the full surround eyeglass frames, they will also allow for easier programming of the tasks each lens will perform—on the inside left will be displaying the voice interpreted into sign language plus a caller ID indicator across the top, the exterior left and right lens will have the ability to offer a transition lens that will darken slightly in bright light to allow comfort for the wearer as well as additional ability to add device wearer's necessary eye correction prescription allowing this lens to easily be replaced or upgraded without unnecessary repurchase of entire device but rather, cost only for the new lens and outside eyewear/optometry upgrade(s). Inside the interior right lens will offer indicator lights on sound level selected and an confirmation light that device is on.

The wearable device offers the wearer the ability to adjust the volume of the spoken voice via a sliding or button switch on the glass earpiece, which is confirmed by a placement level displayed as a colored box on the interior right lens; turn it on or off with a switch on the opposing earpiece on the glasses, confirmed by a colored line on the left lens as to whether it is actively on.

The microphone imbedded into the device's frame is echo cancelling, filtering, wind noise suppression, dynamics processing, noise cancelling, and other functions, using a graphical user interface environment modular programming software, allowing it to differentiate between sound directed toward them versus general surrounding noises/voices and other interferences. Further testing during development will refine that feature.

The device's WiFi capability will allow it to be customized with a Smartphone device, tablet, or through a private webpage on the manufacturer's managing website, with such customizations as selecting the gender and general age for the voice to be transmitted. The initial roll-out devices will be offering “male” and “female” for gender options, and “toddler”, “age 5-8”, “age 8-14”, “young adult”, and “adult” for voice age.

It will include Bluetooth capability during a phase of its development to allow the user to feel a vibration upon receiving a phone call as well as caller ID flash on the left interior lens—they will have the usual option to reject taking the call or accept the call. Upon accepting the call, the caller's voice will feed into the voice receiver system and offer the translation service by transferring the conversation into sign language on the lens as if the speaker were physically with them. The wearer will be able to respond with their sign language and it will be interpreted into a voice, sounding either through the microphone for public consumption, or the wearer may select the voice “silent” mode and the “voice” interpretation will be fed privately into the cell phone/tablet for only the caller to hear.

The device will be offered initially for American English speaking/interpretation with American Sign Language interpretation, however, future versions will allow the wearer to select from a constant growing offering of other speaking languages and dialects, and sign language interpretations. These features will accommodate the diverse ethnicities unique to each community worldwide.

Wearable Device Specifications Are:

Computer specifications for the wearable device and enhancements: The device will use energy aware embedded system design techniques, technologies and statistical Markov model algorithms, Python, likely other coding languages such as R and latest developments in Machine Learning that reduce the total signal chain current consumption in order of magnitude into the micro-amps enabling hands-free voice recognition as well as hand gestures recognition of sign language interpretations converted into speech. Added WiFi technology will allow it to interact with the wearer's Smartphone, private web page on the manufacturer's managing webpage, and other personal WiFi-shared devices so the wearable device can be customized to the users' preferences currently offered. The microphone used will be embedded in the front outer edge on one side of the eyewear, and a speaker embedded on the opposite outer edge, appearing to be a decorative piece. The input/output microphone will have the ability to interact with Bluetooth technology. Upgrades may include neural networking/machine learning intelligence.

Incoming phone calls fed to the Bluetooth, if the Bluetooth is on, will result in a vibration on one of the earpieces to signal an incoming phone call to the individual as well as offer a caller ID (name and/or phone number identification) on the left lens to advise the wearer who is calling. The Bluetooth technology will offer the same services other Bluetooth users enjoy. A button will be readily available on one of the earpieces to dictate if a call will be accepted, or to turn that portion of the device off.

Images on the interior left lens will be fed to it from a database through Wi-Fi capabilities which will continually upgrade, likely as a subscription service. Any caller ID and indicator lights added will be part of the devices' pre-installed technology.

Device manufacturers have not been selected at this time so exact specifics of device enhancements will be a process in development until said product has been manufactured for distribution—the importance is the design will accommodate the enhancements required for this invention to function, that being the unique lenses discreetly display the sign language information to the wearer only, the outer coating on the lenses to preserve their function of clear vision to the wearer and their ability to accommodate a visual prescription, if needed, and any other unique options the wearer may choose such as transitional shading, for example.

The device manufacturing would incorporate the unique duo microphone and sound level features that interprets into sign language onto an interior lens, motion/camera detection and interpretation into sound via speaker, power control, the device's status light indicator(s) as well as its Wi-Fi and Bluetooth technology abilities.

The eyeglass device will have a unique charging strip on the underside of one of the lens frames—when placed in its unique protective display case that is equipped with a charger system, the charging strip will sit on the case stations' charging strip for a quick recharge of sealed battery service.

1. Wearable eyewear imbedded with a sound receptor will hear a voice spoken towards it and interpret that voice into a selected sign language translation which will display on one of the inside lens to “speak” to the wearer.

2. Wearer of eyeglass device will be able to interact with others by signing their chosen sign language translation in front of the eyeglass lens, which is instantly fed to a verified database which will in turn interpret the signed conversation to voice through a microphone imbedded in the frames of the eyewear device.

3. Wearer will have the ability to see if the device is on/charged, select to have the “voice” off or select different sound levels of ‘whisper’, ‘low’, ‘average’.

4. Device will work in association with a database maintained by inventor's lab and company services that will offer constantly updated sign language and spoken voice translations and presentation, updating coding, via Wi-Fi connection; in turn, they will have the ability to customize their experience from their own private webpage provided to them upon purchase of the device, accessible by most any mobile device they choose to use. Customization will provide the ability to select gender, age group, and eventually specific language and dialects of their choice so they may interact with others more appropriately within their living Region as well as speak other languages, sign language and spoken from around the world. Upgrades will offer musical ability and addition of more languages and dialects.

5. Wi-Fi capabilities.

6. Bluetooth capabilities—phone calls to the individuals' cell phone can be linked to the device through installed Bluetooth technology, vibrating an earpiece to indicate an incoming and caller identification displaying inside left lens so wearer may decide if they wish to accept call. They have option to decline call and it goes to voicemail supplied by their mobile service provider or they may accept call. If they answer call, they can interact publicly or privately using same methods of a spoken voice directed to them.

7. ability to now interact with nearly all populations in any setting including having the ability to take higher education without requiring an interpreter, pursuing work and in fields traditionally off limits due to hearing limitations or safety issues, and eventually participate in singing events.

8. interaction with modern voice recognition devices such as Amazon Echo or Google Home, for example, to allow the wearer the ability to request groceries, services, and other services they offer allowing independence.
